(19) United States
(12) Patent Application Publication
(10) Pub. No.: US 2024/0213777 A1
(43) Pub. Date: Jun. 27, 2024

(54) DEVICE AND METHOD FOR LOOP CLOSING AND BREAKING OF POWER DISTRIBUTION GRID BASED ON DECOUPLED VOLTAGE REGULATION, AND POWER DISTRIBUTION GRID

(71) Applicants: STATE GRID JIANGSU ELECTRIC POWER RESEARCH INSTITUTE, Nanjing, Jiangsu (CN); JIANGSU ELECTRIC POWER RESEARCH INSTITUTE CO., LTD., Nanjing, Jiangsu (CN)

(72) Inventors: Qun LI, Nanjing, Jiangsu (CN); Ningyu ZHANG, Nanjing, Jiangsu (CN); Qian ZHOU, Nanjing, Jiangsu (CN); Jiankun LIU, Nanjing, Jiangsu (CN); Jian LIU, Nanjing, Jiangsu (CN); Jing CHEN, Nanjing, Jiangsu (CN); Xinyao ZHU, Nanjing, Jiangsu (CN); Lei GAO, Nanjing, Jiangsu (CN); Peng LI, Nanjing, Jiangsu (CN); Jinjiao LIN, Nanjing, Jiangsu (CN); Jianhua ZHOU, Nanjing, Jiangsu (CN)

(73) Assignees: STATE GRID JIANGSU ELECTRIC POWER RESEARCH INSTITUTE, Nanjing, Jiangsu (CN); JIANGSU ELECTRIC POWER RESEARCH INSTITUTE CO., LTD., Nanjing, Jiangsu (CN)

(21) Appl. No.: 18/556,025

(22) PCT Filed: Feb. 10, 2022
(86) PCT No.: PCT/CN2022/075832

§ 371 Date: Oct. 18, 2023

(30) Foreign Application Priority Data
May 13, 2021 (CN) 202110524738.8

(51) Int. Cl. H02J 3/12

(52) U.S. Cl. CPC H02J 3/12

(57) ABSTRACT

A device for loop closing and breaking of a power distribution grid based on decoupled voltage regulation is provided. The device comprises a voltage-regulation phase shifter, a control system, a voltage acquisition device and a loop closing switch. The voltage acquisition device acquires voltage signals on two sides of the loop closing switch performing a loop closing or breaking operation and transmits the voltage signals to the control system. The control system calculates a compensating voltage amplitude and phase-angle according to the voltage signals, and sends an instruction to the voltage-regulation phase shifter according to the compensating voltage amplitude and phase-angle. The voltage-regulation phase shifter outputs the compensating voltage amplitude and phase-angle according to the instruction from the control system, to compensate for a voltage difference between the two sides of the loop closing switch.

### FIELD

The invention relates to the technical field of operation of power distribution grids, in particular to a device and method for loop closing and braking of a power distribution grid based on decoupled voltage regulation, and a power distribution grid.

### BACKGROUND

Current power distribution grids in China operate in an open-loop manner. That is, during normal operation, the load is supplied by one distribution line; and in case of a fault or maintenance of the line, the load is transferred to lines through a power distribution grid to be supplied with power. Traditional power distribution lines transfer the load to other lines after a power failure, which cannot meet the requirement for uninterrupted continuous power supply anymore.

At present, most power distribution lines capable of meeting the requirements for continuous power supply of users are operated in a closed-loop manner, and under the influence of the operation condition of the system and the parameters of the power distribution grids, the risks such as equipment overload, false tripping of relay protection, out-of-limit short circuit current, and failure propagation resulting from electromagnetic looped networks may be caused by an excessive loop closing current. The main problem caused by the loop closing operation is an excessive loop closing current due to a voltage phase difference between busbars on two sides of a loop closing switch or an interconnection switch before loop closing, which will lead to false tripping of quick-break protection or overcurrent protection, power failures in a larger area, and bad consequences.

In view of the above problems, the inventor designs a device and method for loop closing and breaking of a power distribution grid based on decoupled voltage regulation, and a power distribution grid through active study and innovation based on years of rich practical experience and professional knowledge in engineering application of such products, by employing scientific principles or laws.

### SUMMARY

The invention provides a device for loop closing and breaking of a power distribution grid based on decoupled voltage regulation to solve the problems mentioned in the description of related art. The invention further claims protection for a method for loop closing and breaking of a power distribution grid based on decoupled voltage regulation, and a power distribution grid, which have the same technical effects.

The technical solution adopted by the invention to fulfill the above objective is as follows:

A device for loop closing and breaking of a power distribution grid based on decoupled voltage regulation comprises a voltage-regulation phase shifter, a control system, a voltage acquisition device and a loop closing switch, wherein:

The voltage acquisition device acquires voltage signals on both sides of the loop closing switch performing a loop closing or breaking operation and transmits the voltage signals to the control system;

The control system calculates a compensating voltage amplitude and phase-angle according to the voltage signals, and sends an instruction to the voltage-regulation phase shifter according to the compensating voltage amplitude and phase-angle;

The voltage-regulation phase shifter outputs the compensating voltage amplitude and phase-angle according to the instruction from the control system.

Further, the voltage-regulation phase shifter comprises a parallel transformer and a series transformer;

The parallel transformer is a three-phase three-winding auto-transformer, and comprises primary-side auto-couplings a1, b1 and c1, and secondary-side windings a2, b2 and c2;

The series transformer comprises amplitude regulation parts ΔUₐ₁, ΔU_{b1} and ΔU_{c1}, and phase-angle regulation parts ΔUₐ₂, ΔU_{b2} and ΔU_{c2}; the amplitude regulation parts ΔUₐ₁, ΔU_{b1} and ΔU_{c 1}adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer;

The control system is connected to taps of the primary-side auto-couplings and taps of the secondary-side windings.

A method for loop closing and breaking of a power distribution grid based on decoupled voltage regulation comprises the following steps:

Acquiring voltage signals on both sides of a loop closing switch which performs a loop closing or breaking operation:

Calculating a compensating voltage amplitude and phase-angle according to the voltage signals; and

Outputting a compensating voltage through voltage regulation to compensate for the compensating voltage amplitude and phase-angle, and then, performing the loop closing or breaking operation.

Further, a parallel transformer and a series transformer are used for voltage regulation:

The parallel transformer is a three-phase three-winding auto-transformer, and comprises primary-side auto-couplings a1, b1 and c1, and secondary-side windings a2, b2 and c2;

The series transformer comprises amplitude regulation parts ΔUₐ₁, ΔU_{b1} and ΔU_{c1}, and phase-angle regulation parts ΔUₐ₂, ΔU_{b2} and ΔU_{c2}; wherein, the amplitude regulation parts 4 Ual, ΔU_{b1} and ΔU_{c1} adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer;

Decoupled control of the compensating voltage amplitude and phase-angle is realized through independent regulation of taps of the primary-side auto-windings and taps of the secondary-side windings.

A power distribution grid comprises:

A first power supply circuit comprising a power supply S₁, a loop closing switch K₁ and a load R₁ which are connected in series;

A second power supply circuit comprising a power supply S₂, a loop closing switch K₂ and a load R₂ which are connected in series; and

A voltage-regulation phase shifter, a control system and a voltage acquisition device;

A side, connected to the load R₁, of the loop closing switch K₁ is connected to the voltage-regulation phase shifter through a loop closing switch K₃; a side, connected to the load R₂, of the loop closing switch K₂ is connected to the voltage-regulation phase shifter through a loop closing switch K₄; the voltage acquisition device is connected to the control system, the loop closing switch K₁, the loop closing switch K₂, the loop closing switch K₃ and the loop closing switch K₄, acquires voltage signals on two sides of a designated loop closing switch, and transmits the voltage signals to the control system;

The control system calculates a compensating voltage amplitude and phase-angle according to the voltage signals, and sends an instruction to the voltage-regulation phase shifter according to the compensating voltage amplitude and phase-angle;

The voltage-regulation phase shifter outputs the compensating voltage amplitude and phase- angle according to the instruction from the control system.

Further, the voltage-regulation phase shifter comprises a parallel transformer and a series transformer;

The parallel transformer is a three-phase three-winding auto-transformer, and comprises primary-side auto-couplings a1, b1 and c1, and secondary-side windings a2, b2 and c2;

The series transformer comprises amplitude regulation parts ΔUₐ₁, ΔU_{b1} and ΔU_{c1}, and phase-angle regulation parts ΔUₐ₂, ΔU_{b2} and ΔU_{c2}; the amplitude regulation parts ΔUₐ₁, ΔU_{b1} and ΔU_{c1} adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer;

The control system is connected to taps of the primary-side auto-couplings and taps of the secondary-side windings.

Further, when the power distribution grid operates normally, the loop closing switch K₁ and the loop closing switch K₂ are closed, the power supply S₁ supplies power to the load R₁, and the power supply S₂ supplies power to the load R₂; when a loop closing operation of the power distribution grid is needed, the following steps are performed:

Closing the loop closing switch K₃, and connecting the voltage-regulation phase shifter to the power distribution grid;

Acquiring, by the control system, voltages on two sides of the loop closing switch K₄, and calculating a compensating voltage according to a difference between the voltages on the two sides;

Calculating, by the control system, an operating position of the voltage-regulation phase shifter according to the compensating voltage, and sending the operating position to the voltage-regulation phase shifter to implement a voltage-regulation phase shift; and

Recalculating, by the control system, the voltages on the two sides the loop closing switch K₄ until the compensating voltage is less than a set threshold, closing the loop-closing switch K₄ to complete loop closing, and opening the loop closing switch K₂ to complete loop breaking, and supplying power to the load R₂ by the power supply S₁.

Further, when a line on the power supply S₂ side of the power distribution grid is under maintenance, the loop closing switch K₁, the loop closing switch K₃ and the loop closing switch K₄ are closed, the loop closing switch K₂ is opened, and the power supply S₁ supplies power to the load R₁ and the load R₂; when the load R₂ is switched to be supplied with power by the power supply S₂ independently after the line on the power supply S₂ side is maintained, a loop breaking operation of the power distribution grid is performed through the following steps:

Acquiring, by the control system, voltages on two sides of the loop closing switch K₂, and calculating a compensating voltage according to a difference between the voltages on the two sides;

Controlling, by the control system, the voltage-regulation phase shifter to perform voltage regulation according to the compensating voltage; and

Recalculating, by the control system, the voltages on the two sides the loop closing switch K₂ until the compensating voltage is less than a set threshold, closing the loop-closing switch K₂ to complete loop closing, and opening the loop closing switch K₄ to complete loop breaking, and supplying power to the load R₂ by the power supply S₂.

Further, the control system realizes decoupled control of the compensating voltage amplitude and phase-angle through independent regulation of the taps of the primary-side auto-couplings and the taps of the secondary-side windings.

By adoption of the technical solution, the invention has the following technical effects:

Through the voltage-regulation phase shift, the loop closing or breaking operation can be effectively implemented in case of a large difference in amplitude and phase angle of bus voltages of the power distribution gird, an excessive loop closing current can be effective avoided in the loop closing process, and false tripping of quick-break protection or over-current protection is avoided.

### BRIEF DESCRIPTION OF THE DRAWINGS

To more clearly explain the technical solutions of the embodiments of the invention or the prior art, drawings used for describing the embodiments of the invention or the prior art will be briefly introduced below. Obviously, the drawings in the following description merely illustrate some embodiments of the invention, and those ordinarily skilled in the art can obtain other drawings according to the following ones without creative labor.

FIG. 1 is a structural diagram of a device for loop closing and breaking of a power distribution grid based on decoupled voltage regulation;

FIG. 2 is a structural diagram of a voltage-regulation phase shifter;

FIG. 3 is a flow diagram of a method for loop closing and breaking of a power distribution grid based on decoupled voltage regulation;

FIG. 4 is a structural diagram of a power distribution grid used based on the device for loop closing and breaking of a power distribution grid based on decoupled voltage regulation;

FIG. 5 is a schematic diagram of a loop closing process of the power distribution grid;

FIG. 6 is a schematic diagram of a loop breaking process of the power distribution grid.

### DETAILED DESCRIPTION

The technical solutions of the embodiments of the invention will be clearly and completely described below in conjunction with the drawings of these embodiments. Obviously, the embodiments in the following description are merely illustrative ones, and are not all possible ones of the invention.

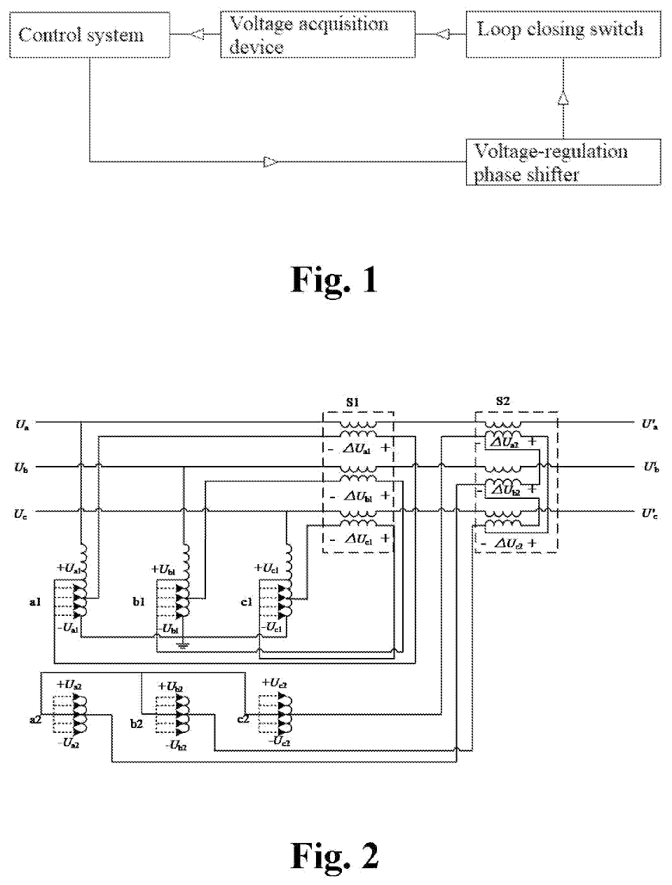

As shown in FIG. 1, a device for loop closing and breaking of a power distribution grid based on decoupled voltage regulation comprises: a voltage-regulation phase shifter, a control system, a voltage acquisition device and a loop closing switch; the voltage acquisition device acquires voltage signals on two sides of the loop closing switch performing a loop closing or breaking operation and transmits the voltage signals to the control system; the control system calculates a compensating voltage amplitude and phase-angle according to the voltage signals and sends an instruction to the voltage-regulation phase shifter according to the compensating voltage amplitude and phase-angle; and the voltage-regulation phase shifter outputs the compensating voltage amplitude and phase angle according to the instruction from the control system, to compensate for a voltage difference between the two sides of the loop closing switch.

According to the invention, through a voltage-regulation phase shift, the loop closing or breaking operation can be effectively implemented in case of a large difference in amplitude and phase angle of bus voltages of a power distribution gird, an excessive loop closing current can be effective avoided in the loop closing process, and false tripping of quick-break protection or over-current protection is avoided.

Preferably, as shown in FIG. 2, the voltage-regulation phase shifter comprises a parallel transformer and a series transformer; the parallel transformer is a three-phase three-winding auto-transformer, and comprises primary-side auto-couplings a1, b1 and c1, and secondary-side windings a2, b2 and c2; the series transformer comprises amplitude regulation parts ΔUₐ₁, ΔU_{b1} and ΔU_{c1} which form a series winding S1, and phase-angle regulation parts ΔUₐ₂, ΔU_{b2} and ΔU_{c2} which form a series winding S2; the amplitude regulation parts ΔUₐ₁, ΔU_{b1} and ΔU_{c1} adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer; and the control system is connected to taps of the primary-side auto-couplings and taps of the secondary-side windings.

The primary-side auto-couplings a1, b1 and c1 of the three-phase three-winding auto-coupling transformer, and the series winding S1 control the amplitudes ΔUₐ₁, ΔU_{b1} and ΔU_{c1} of a compensating voltage, the secondary-side windings a2, b2 and c2, and the series winding S2 control the phase angles ΔUₐ₂, ΔU_{b2} and ΔU_{c2} of the compensating voltage, and primary sides of exciting windings are shared, so one winding is omitted; the series winding S1 and the series winding S2 on the series side regulate the amplitude and phase angle of the voltage respectively, so when a fault happens to one series winding, the other series winding can still participate in flow regulation of the power distribution grid, thus improving the operating stability of the device.

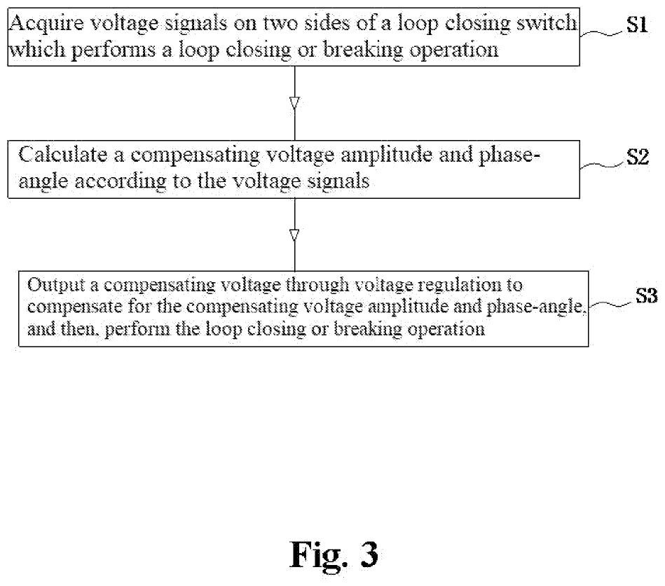

As shown in FIG. 3, a method for loop closing and breaking of a power distribution grid based on decoupled voltage regulation comprises the following steps:

S1: voltage signals on two sides of a loop closing switch performing a loop closing or breaking operation are acquired;

S2: a compensating voltage amplitude and phase-angle are calculated according to the voltage signals; and

S3: a compensating voltage is output through voltage regulation to compensate for the compensating voltage amplitude and phase-angle, and then, the loop closing or breaking operation is performed.

According to the method, in the voltage regulation process, a parallel transformer and a series transformer are used for voltage regulation; the parallel transformer is a three-phase three-winding auto-transformer, and comprises primary-side auto-couplings a1, b1 and c1, and secondary-side windings a2, b2 and c2; the series transformer comprises amplitude regulation parts ΔUₐ₁, ΔU_{b1} and ΔU_{c1}, and phase-angle regulation parts ΔUₐ₂, ΔU_{b2} and ΔU_{c2}; wherein, the amplitude regulation parts ΔUₐ₁, ΔU_{b1} and ΔU_{c1} adopt delta connection and are connected to the primary-side auto-couplings of the parallel transformer; and the phase-angle regulation parts ΔUₐ₂, ΔU_{b2} and ΔU_{c2} adopt star connection and are connected to the secondary-side windings of the parallel transformer.

Decoupled control of the compensating voltage amplitude and phase-angle is realized through independent regulation of taps of the primary-side auto-windings and taps of the secondary-side windings. Through independent regulation of the taps, when a fault happens to one series winding, the other series winding can still participate in flow regulation of the power distribution grid; by setting the positions of the taps of the primary-side auto-couplings and the secondary-side windings of the voltage-regulation phase shifter, the amplitude and phase angle of busbar voltages on two sides are regulated to be within a certain threshold, such that the loop current during loop closing and breaking is reduced, safe loop closing and breaking are realized, the influence of loop closing and breaking on normal operation of the power distribution grid can be effectively avoided, and the power supply reliability and safety are improved.

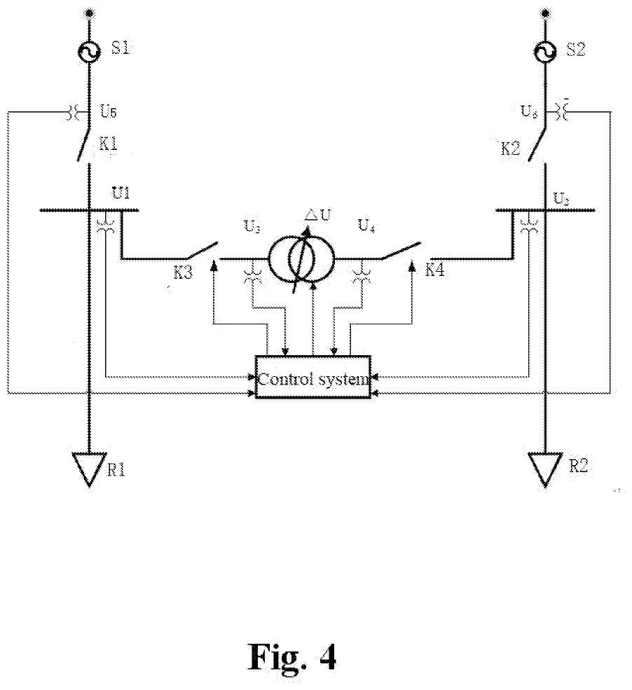

As shown in FIG. 4, a power distribution grid comprises: a first power supply circuit comprising a power supply S₁, a loop closing switch K₁ and a load R₁ which are connected in series; a second power supply circuit comprising a power supply S₂, a loop closing switch K₂ and a load R₂ which are connected in series; and a voltage-regulation phase shifter, a control system and a voltage acquisition device; a side, connected to the load R₁, of the loop closing switch K₁ is connected to the voltage-regulation phase shifter through a loop closing switch K₃; a side, connected to the load R₂, of the loop closing switch K₂ is connected to the voltage-regulation phase shifter through a loop closing switch K₄; the voltage acquisition device is connected to the control system, the loop closing switch K₁, the loop closing switch K₂, the loop closing switch K₃ and the loop closing switch K₄, acquires voltage signals on two sides of a designated loop closing switch, and transmits the voltage signals to the control system; the control system calculates a compensating voltage amplitude and phase-angle according to the voltage signals, and sends an instruction to the voltage-regulation phase shifter according to the compensating voltage amplitude and phase-angle; and the voltage-regulation phase shifter outputs the compensating voltage amplitude and phase-angle according to the instruction from the control system, to compensate for a voltage difference between the two sides of the designated loop closing switch.

In the power distribution grid, only the minimum unit that can fulfill the technical purpose of the invention is protected, and the use of other elements without affecting the working principle of the invention also falls within the protection scope of the invention. The number of the power supply circuits can be further increased as long as the power supply circuits can be connected to the voltage-regulation phase shifter through branch circuits and loop closing switches. During loop closing and breaking process, the two power supply circuits involved in the invention are substantively two power supply circuits participate in the loop closing and breaking.

Wherein, the voltage-regulation phase shifter comprises a parallel transformer and a series transformer; the parallel transformer is a three-phase three-winding auto-transformer, and comprises primary-side auto-couplings a1, b1 and c1, and secondary-side windings a2, b2 and c2; The series transformer comprises amplitude regulation parts ΔUₐ₁, ΔU_{b1} and ΔU_{c1}, and phase-angle regulation parts ΔUₐ₂, ΔU_{b2} and ΔU_{c2}; the amplitude regulation parts ΔUₐ₁, ΔU_{b1} and ΔU_{c1} adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer; and the control system is connected to taps of the primary-side auto-couplings and taps of the secondary-side windings. The technical effects fulfilled by the preferred solution are identical with the technical effects of the above embodiments, and will no longer be detailed here.

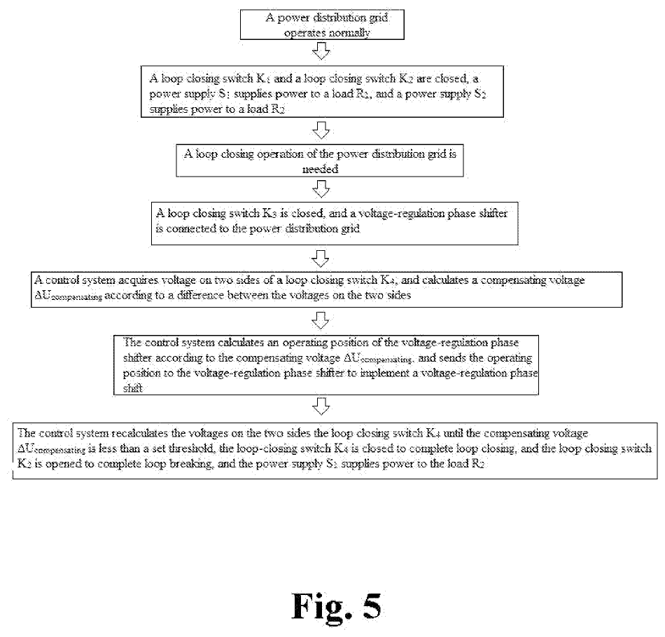

During the specific working process, as shown in FIG. 5, when the power distribution grid operates normally, the loop closing switch K₁ and the loop closing switch K₂ are closed, the power supply S₁ supplies power to the load R₁, and the power supply S₂ supplies power to the load R₂; when a loop closing operation of the power distribution grid is needed, the following steps are performed: the loop closing switch K₃ is closed, and the voltage-regulation phase shifter is connected to the power distribution grid; the control system acquires voltages on two sides of the loop closing switch K₄, and calculates a compensating voltage ΔU_{compensating} according to a difference between the voltages on the two sides; the control system calculates an operating position of the voltage-regulation phase shifter according to the compensating voltage ΔU_{compensating}, and sends the operating position to the voltage-regulation phase shifter to implement a voltage-regulation phase shift; and the control system recalculates the voltages on the two sides the loop closing switch K₄ until the compensating voltage ΔU_{compensating} is less than a set threshold, the loop-closing switch K₄ is closed to complete loop closing, and the loop closing switch K₂ is opened to complete loop breaking, and the power supply S₁ supplies power to the load R₂.

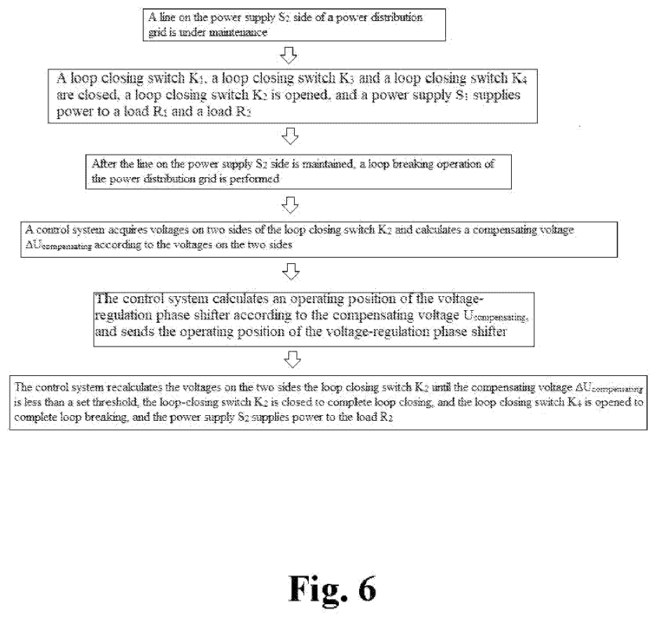

As shown in FIG. 6. when a line on the power supply S₂ side of the power distribution grid is under maintenance, the loop closing switch K₁, the loop closing switch K₃ and the loop closing switch K₄ are closed, the loop closing switch K₂ is opened, and the power supply S₁ supplies power both to the load R₁ and the load R₂; when the load R₂ is switched to be supplied with power by the power supply S₂ independently after the line on the power supply S₂ side is maintained, a loop breaking operation of the power distribution grid is performed through the following steps:

The control system acquires voltages on two sides of the loop closing switch K₂ and calculates a compensating voltage ΔU_{compensating} according to the voltages on the two sides; the control system controls the voltage-regulation phase shifter to perform voltage regulation according to the compensating voltage ΔU_{compensating}; and the control system recalculates the voltages on the two sides the loop closing switch K₂ until the compensating voltage AUcompensating is less than a set threshold, the loop-closing switch K₂ is closed to complete loop closing, and the loop closing switch K₄ is opened to complete loop breaking, and the power supply S₂ supplies power to the load R₂ to.

The basic principle, main features and advantages of the invention are illustrated and described above. Those skilled in the art should appreciate that the invention is not limited to the above embodiments, these embodiments and the description in this specification are merely used to explain the principle of the invention, various transformations and improvements can be made to the invention without departing from the spirit and scope of the invention, and all these transformations and improvements should fall within the protection scope of the invention. The protection scope of the invention is defined by the appended claims and their equivalents.

What is claimed is:

1. A device for loop closing and breaking of a power distribution grid based on decoupled voltage regulation, comprising: a voltage-regulation phase shifter, a control system, a voltage acquisition device and a loop closing switch, wherein:
the voltage acquisition device acquires voltage signals on two sides of the loop closing switch performing a loop closing or breaking operation and transmits the voltage signals to the control system;
the control system calculates a compensating voltage amplitude and phase-angle according to the voltage signals, and sends an instruction to the voltage-regulation phase shifter according to the compensating voltage amplitude and phase-angle;
the voltage-regulation phase shifter outputs the compensating voltage amplitude and phase-angle according to the instruction from the control system, to compensate for a voltage difference between the two sides of the loop closing switch.

2. The device for loop closing and breaking of a power distribution grid based on decoupled voltage regulation according to claim 1, wherein the voltage-regulation phase shifter comprises a parallel transformer and a series transformer;
the parallel transformer is a three-phase three-winding auto-transformer, and comprises primary-side auto-couplings a1, b1 and c1, and secondary-side windings a2, b2 and c2;
the series transformer comprises amplitude regulation parts ΔUₐ₁, ΔU_{b1} and ΔU_{c1}, and phase-angle regulation parts ΔUₐ₂, ΔU_{b2} and ΔU_{c2}; the amplitude regulation parts ΔUₐ₁, ΔU_{b1} and ΔU_{c1} adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer;
the control system is connected to taps of the primary-side auto-couplings and taps of the secondary-side windings.

3. A method for loop closing and breaking of a power distribution grid based on decoupled voltage regulation, comprising:
acquiring voltage signals on two sides of a loop closing switch which performs a loop closing or breaking operation;
calculating a compensating voltage amplitude and phase-angle according to the voltage signals; and
outputting a compensating voltage through voltage regulation to compensate for the compensating voltage amplitude and phase-angle, and then, performing the loop closing or breaking operation.

4. The method for loop closing and breaking of a power distribution grid based on decoupled voltage regulation according to claim 3, wherein a parallel transformer and a series transformer are used for voltage regulation;
the parallel transformer is a three-phase three-winding auto-transformer, and comprises primary-side auto-couplings a1, b1 and c1, and secondary-side windings a2, b2 and c2;
the series transformer comprises amplitude regulation parts ΔUₐ₁, ΔU_{b1} and ΔU_{c1}, and phase-angle regulation parts ΔUₐ₂, ΔU_{b2} and ΔU_{c2}; wherein, the amplitude regulation parts ΔUₐ₁, ΔU_{b1} and ΔU_{c1} adopt delta connection and are connected to the primary-side auto-couplings of the parallel transformer: the phase-angle regulation parts ΔUₐ₂, ΔU_{b2} and ΔU_{c2} adopt star connection and are connected to the secondary-side windings of the parallel transformer;
decoupled control of the compensating voltage amplitude and phase-angle is realized through independent regulation of taps of the primary-side auto-windings and taps of the secondary-side windings.

5. A power distribution grid, comprising:
a first power supply circuit comprising a power supply S₁, a loop closing switch K₁ and a load R₁ which are connected in series;
a second power supply circuit comprising a power supply S₂, a loop closing switch K₂ and a load R₂ which are connected in series; and
a voltage-regulation phase shifter, a control system and a voltage acquisition device;
wherein, a side, connected to the load R₁, of the loop closing switch K₁ is connected to the voltage-regulation phase shifter through a loop closing switch K₃; a side, connected to the load R₂, of the loop closing switch K₂ is connected to the voltage-regulation phase shifter through a loop closing switch K₄; the voltage acquisition device is connected to the control system, the loop closing switch K₁, the loop closing switch K₂, the loop closing switch K₃ and the loop closing switch K₄, acquires voltage signals on two sides of a designated loop closing switch, and transmits the voltage signals to the control system;
the control system calculates a compensating voltage amplitude and phase-angle according to the voltage signals, and sends an instruction to the voltage-regulation phase shifter according to the compensating voltage amplitude and phase-angle;
the voltage-regulation phase shifter outputs the compensating voltage amplitude and phase-angle according to the instruction from the control system, to compensate for a voltage difference between the two sides of the designated loop closing switch.

6. The power distribution grid according to claim 5, wherein the voltage-regulation phase shifter comprises a parallel transformer and a series transformer;
the parallel transformer is a three-phase three-winding auto-transformer, and comprises primary-side auto-couplings a1, b1 and c1, and secondary-side windings a2, b2 and c2;
the series transformer comprises amplitude regulation parts ΔUₐ₁, ΔU_{b1} and ΔU_{c1}, and phase-angle regulation parts ΔUₐ₂, ΔU_{b2} and ΔU_{c2}; the amplitude regulation parts ΔUₐ₁, ΔU_{b1} and ΔU_{c1} adopt delta connection and are connected to the primary-side auto-couplings of the parallel transformer; the phase-angle regulation parts ΔUₐ₂, ΔU_{b2} and ΔU_{c2} adopt star connection and are connected to the secondary-side windings of the parallel transformer;
the control system is connected to taps of the primary-side auto-couplings and taps of the secondary-side windings.

7. The power distribution grid according to claim 5, wherein
when the power distribution grid operates normally, the loop closing switch K₁ and the loop closing switch K₂ are closed, the power supply S₁ supplies power to the load R₁, and the power supply S₂ supplies power to the load R₂; when a loop closing operation of the power distribution grid is needed, the following steps are performed:
closing the loop closing switch K₃, and connecting the voltage-regulation phase shifter to the power distribution grid;
acquiring, by the control system, voltages on two sides of the loop closing switch k₄, and calculating a compensating voltage according to a difference between the voltages on the two sides;
calculating, by the control system, an operating position of the voltage-regulation phase shifter according to the compensating voltage, and sending the operating position to the voltage-regulation phase shifter to implement a voltage-regulation phase shift; and
recalculating, by the control system, the voltages on the two sides the loop closing switch K₄ until the compensating voltage is less than a set threshold, closing the loop-closing switch K₄ to complete loop closing, and opening the loop closing switch K₂ to complete loop breaking, and supplying power to the load R₂ by the power supply S₁.

8. The power distribution grid according to claim 5, wherein
when a line on the power supply S₂ side of the power distribution grid is under maintenance, the loop closing switch K₁, the loop closing switch K₃ and the loop closing switch K₄ are closed, the loop closing switch K₂ is opened, and the power supply S₁ supplies power to the load R₁ and the load R₂; when the load R₂ is switched to be supplied with power by the power supply S₂ independently after the line on the power supply S₂ side is maintained, a loop breaking operation of the power distribution grid is performed through the following steps:
acquiring, by the control system, voltages on two sides of the loop closing switch K₂, and calculating a compensating voltage according to a difference between the voltages on the two sides;
controlling, by the control system, the voltage-regulation phase shifter to perform voltage regulation according to the compensating voltage; and
recalculating, by the control system, the voltages on the two sides the loop closing switch K₂ until the compensating voltage is less than a set threshold, closing the loop-closing switch K₂ to complete loop closing, and opening the loop closing switch K₄ to complete loop breaking, and supplying power to the load R₂ by the power supply S₂.

9. The power distribution grid according to claim 6, wherein
the control system realizes decoupled control of the compensating voltage amplitude and phase-angle through independent regulation of the taps of the primary-side auto-couplings and the taps of the secondary-side windings.
